(19) United States
(12) Patent Application Publication
(10) Pub. No.: US 2013/0082545 A1
(43) Pub. Date: Apr. 4, 2013

(54) Linear Motor

(71) Applicants: Kengo Goto, Mito (JP); Yasuaki Aoyama, Hitachinaka (JP); Akiyoshi Komura, Hitachi (JP)

(72) Inventors: Kengo Goto, Mito (JP); Yasuaki Aoyama, Hitachinaka (JP); Akiyoshi Komura, Hitachi (JP)

(21) Appl. No.: 13/702,558

(22) PCT Filed: Jun. 8, 2010
(86) PCT No.: PCT/JP2010/059656

§ 371 Date: Dec. 6, 2012

(51) Int. Cl. H02K 41/02

(52) U.S. Cl. CPC H02K 41/02
USPC 310/12.24

(57) ABSTRACT

To provide a linear motor including a mover having an excellent magnetic characteristic even if rigidity is improved, can reduce an amount of magnets, and has high rigidity and less easily bends.
A linear motor according to the present invention is a linear motor (R1) including a propulsion generating mechanism that enables an armature (200) including an armature iron core (100, 101) and an armature winding (2a, 2b) wound around magnetic pole teeth (11, 12) of the armature iron core and a mover (8) including permanent magnets (3) to move relatively to each other. The armature iron core (100, 101) includes the magnetic pole teeth (11, 12) on both sides respectively arranged to be opposed to both surfaces on one side and the other side of the permanent magnets (3) via a gap (4) and a core (1) that connects the magnetic pole teeth (11, 12) on both the sides. A common armature winding (2a, 2b) is arranged on a plurality of the armature iron cores (100, 101). The mover (8) includes the permanent magnets (3) and high magnetic permeability members (5, 6).

### TECHNICAL FIELD

The present invention relates a linear motor used in, for example, a precision positioning device.

### BACKGROUND ART

In the past, a linear motor has structure in which a rotor is cut open and linearly expanded. The linear motor includes a stator that configures an electromagnet including an armature winding and a mover that includes permanent magnets supported by a supporting mechanism movable relatively to the stator via a small gap. Therefore, a magnetic flux causes a large magnetic attraction force to act between the stator, which is the electromagnet, and the mover including the permanent magnet and a burden on the supporting mechanism of the mover increases. In order to realize improvement of the strength of the supporting mechanism, an entire device is increased in size and weight.

Therefore, in order to offset the magnetic attraction force and suppress the increase in the size of the device, a linear motor has emerged in which the magnetic attraction force is offset by alternately arranging a magnetic pole having first polarity that forms a first opposed section and a magnetic pole having second polarity that forms a second opposed section having a magnetic attraction force in a direction opposite to a magnetic attraction force of the first opposed section. PTL 1 describes the linear motor in the past in which the magnetic attraction force is offset.

### CITATION LIST

### Patent Literature

PTL 1: JP-A-2001-28875 (paragraphs 0006 and 0007, FIG. 1, FIG. 2, etc.)
PTL 2: JP-A-2006-320035 (paragraphs 0009, 0024, FIG. 1, FIG. 5, etc.)

### SUMMARY OF INVENTION

### Technical Problem

In the linear motor described in PTL 1, the magnetic attraction force can be offset. Therefore, it is possible to reduce the weight of the mover because the mover can be reduced in thickness. However, since the mover is reduced in thickness, it is likely that the strength of the mover decreases through a reduction in a section modulus.

As a method of solving this problem, PTL 2 explained below is laid open.

PTL 2 describes a linear motor in which slit grooves are arranged in armature teeth of a stator opposed to both front and rear surfaces of permanent magnets of a mover via a gap, the linear motor including, in the permanent magnets of the mover, convex members formed of a nonmagnetic material movable in the slit grooves of the armature teeth of the stator along the slit grooves.

However, in the mover including, in the permanent magnets, the convex members formed of the nonmagnetic material that move in the slit grooves of the armature teeth of the stator described in PTL 2, since the nonmagnetic material is arranged in a magnetic circuit, there is a problem in that magnetic resistance increases. Further, since the convex members are arranged in a moving direction, which is the longitudinal direction, of the mover, the convex members are increased in size (e.g., convex members having length of 2 to 3 m), making it difficult to design and manufacture the mover.

On the other hand, when a method of improving the rigidity of the mover by increasing the thickness of the mover unlike PTL 2, gaps among the armature teeth of the stator increase. Therefore, there is a problem in that magnetic resistance increases and magnetic flux density falls because of the presence of spaces of the gaps.

In view of the above actual circumstances, it is an object of the present invention to provide a linear motor including a mover having an excellent magnetic characteristic even if rigidity is improved, can reduce an amount of magnets, and has high rigidity and less easily bends.

### Solution to Problem

A linear motor according to claim 1 of the present invention is a linear motor including a propulsion generating mechanism that enables an armature including an armature iron core and an armature winding wound around magnetic pole teeth of the armature iron core and a mover including permanent magnets to move relatively to each other. The armature iron core includes the magnetic pole teeth on both sides respectively arranged to be opposed to both surfaces on one side and the other side of the permanent magnets via a gap and a core that connects the magnetic pole teeth on both the sides. A common armature winding is arranged on a plurality of the armature iron cores. The mover includes the permanent magnets and high magnetic permeability members.

### Advantageous Effect of Invention

With the linear motor according to claim 1 of the present invention, it is possible to realize a linear motor including a mover having an excellent magnetic characteristic even if rigidity is improved, can reduce an amount of magnets, and has high rigidity and less easily bends.

### BRIEF DESCRIPTION OF THE DRAWINGS

FIG. 1 is a perspective view showing an armature iron core of a linear motor according to a first embodiment of the present invention.

FIG. 2 is an A-A line sectional view of FIG. 1 showing an armature unit in which an armature winding is applied to a pair of the armature iron cores shown in FIG. 1 arranged in parallel.

FIG. 3A is a perspective view showing a mover including a plurality of mover configuring members, which include high magnetic permeability members and permanent magnets, and a ladder-like mover holding member.

FIG. 3B is a perspective view showing an assembly process for fitting the plurality of mover configuring members, which include the high magnetic permeability members and the permanent magnets, into holes of the mover holding member and assembling the mover.

FIG. 4 is a perspective view showing a part of a liner motor of a propulsion generating mechanism according to the first embodiment.

FIG. 5 is a B-B line sectional view of FIG. 4.

FIG. 6 is a perspective view showing a state in which rectangular parallelepiped high magnetic permeability members are set on upper and lower surfaces of permanent magnets in a first modification of the first embodiment.

FIG. 7 is a perspective view showing a state in which rectangular parallelepiped high magnetic permeability magnetic members having width smaller than the width of magnets are set on upper and lower surfaces of permanent magnets in a second modification of the first embodiment.

FIG. 8A is a perspective view showing a state in which high magnetic permeability members having a trapezoidal shape in cross section are set on upper and lower surfaces of permanent magnets in a third modification of the first embodiment.

FIG. 8B is a perspective view showing a state in which high magnetic permeability members having a convex shape are set on upper and lower surfaces of permanent magnets in a fourth modification of the first embodiment.

FIG. 9 is a perspective view showing a state in which high magnetic permeability members having a step-like shape are set on upper and lower surfaces of a permanent magnet in a fifth modification of the first embodiment.

FIG. 10A is a perspective view showing an example in which high magnetic permeability members are set in a shape oblique to magnetic pole teeth on upper and lower surfaces of permanent magnets in a sixth modification of the first embodiment.

FIG. 10B is a perspective view showing an example in which high magnetic permeability members are set in a shape oblique to magnetic pole teeth on upper and lower surfaces of permanent magnets in a seventh modification of the first embodiment.

FIG. 10C is a perspective view showing an example in which high magnetic permeability members are set in a shape oblique to magnetic pole teeth on upper and lower surfaces of permanent magnets in an eighth modification of the first embodiment.

FIG. 11A is a perspective view showing an example of a mover configuring member including high magnetic permeability members having various shapes and a permanent magnet in the first embodiment.

FIG. 11A is a perspective view showing an example of a mover configuring member including high magnetic permeability members having various shapes and a permanent magnet in the first embodiment.

FIG. 11C is a perspective view showing an example of a mover configuring member including high magnetic permeability members having various shapes and a permanent magnet in the first embodiment.

FIG. 12A is a perspective view showing an assembly process for a mover in a second embodiment.

FIG. 12B is a perspective view showing the assembled mover in the second embodiment.

FIG. 13 is a longitudinal sectional view showing an armature unit including a mover including two permanent magnets and high magnetic permeability members and mover holding members held by the two permanent magnets in a third embodiment.

FIG. 14 is a perspective view showing an example in which permanent magnets are set on upper and lower surfaces of a long flat high magnetic permeability member in a first modification of the third embodiment.

FIG. 15A is a perspective view showing an example of a member for mechanically fixing a mover in the first modification of the third embodiment.

FIG. 15B is a perspective view showing a mover including the flat high magnetic permeability member and the permanent magnets integrated with C-shaped mover holding members in the first modification of the third embodiment.

FIG. 15C is a C-C line sectional view of FIG. 15B.

FIG. 16A is a perspective view showing an example of a long flat high magnetic permeability member in which grooves are set in a second modification of the third embodiment.

FIG. 16B is a perspective view showing an example of a mover in which permanent magnets are set in the grooves on upper and lower surfaces of the high magnetic permeability member in the second modification of the third embodiment.

FIG. 17A is a longitudinal sectional view showing a mover including high magnetic permeability members formed by laminated steel plates set on upper and lower surfaces of permanent magnets, the permanent magnets, and a mover holding member in a third modification of the third embodiment.

FIG. 17B is a longitudinal sectional view showing a mover including high magnetic permeability members formed by laminated steel plates, permanent magnets set on upper and lower surfaces of the high magnetic permeability members, and a mover holding member.

FIG. 18 is a perspective view showing a linear motor in which three armature units using movers in the first to third embodiments are arranged in a fourth embodiment.

### DESCRIPTION OF EMBODIMENTS

Embodiments of the invention are explained below with reference to the accompanying drawings.

### First Embodiment

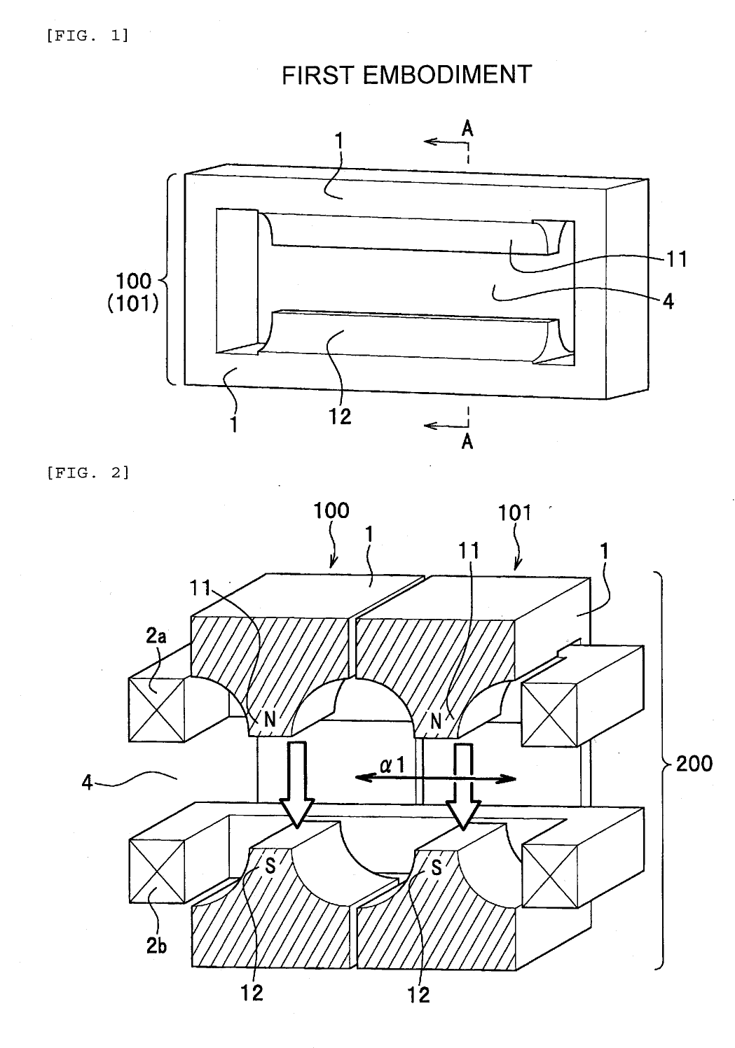

A perspective view of an armature iron core 100 of a linear motor according to a first embodiment of the present invention is shown in FIG. 1.

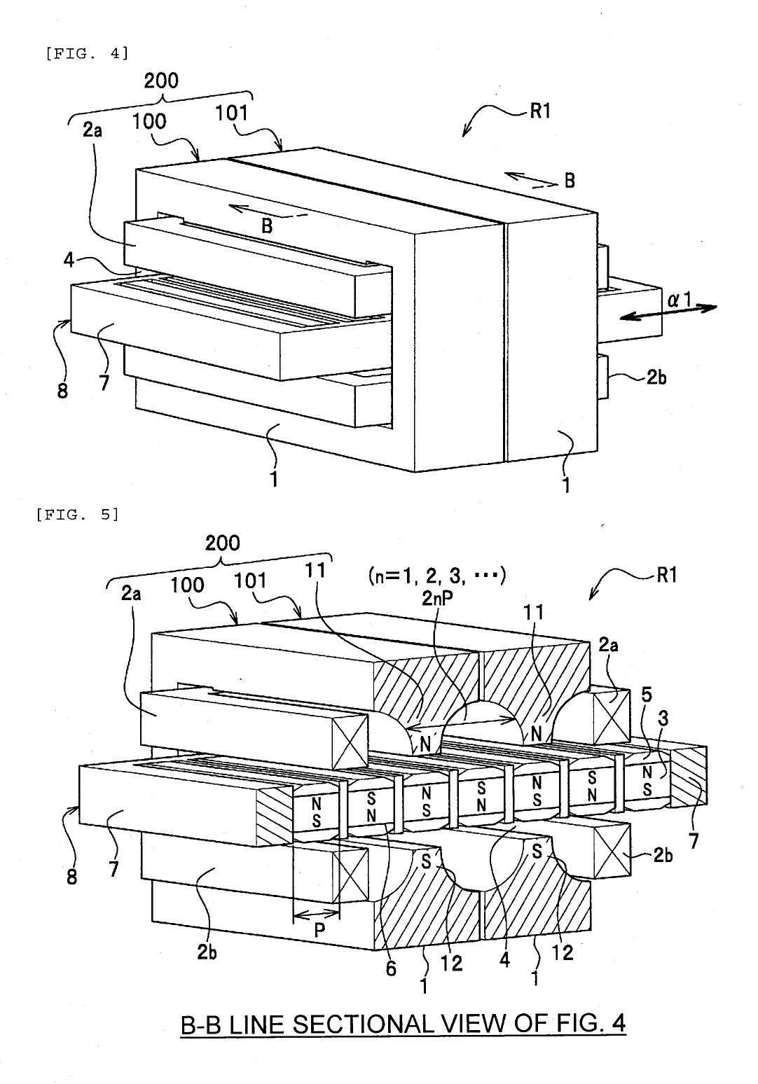

An armature iron core 100 (101) forming a stator of a linear motor R1 (see FIG. 4) includes a magnetic pole tooth 11 on an upper side, a magnetic pole tooth 12 on a lower side arranged to be opposed to the magnetic pole tooth 11 on the upper side via a gap 4, and an iron core (a core) 1 that connects the magnetic pole tooth 11 on the upper side and the magnetic pole tooth 12 on the lower side.

A longitudinal sectional view (same as an A-A line sectional view of FIG. 1) of an armature unit 200 in which armature windings 2a and 2b are applied to two armature iron cores 100 and 101 in FIG. 1 disposed in parallel is shown in FIG. 2. FIG. 2 is a figure in which the armature unit 200 is cut. Therefore, the armature windings 2a and 2b respectively arranged around the magnetic pole teeth 11 and 12 are shown in a state in which front sides thereof are cut.

Magnetic poles (N) of magnetic pole teeth 11 on the upper side and magnetic poles (S) of magnetic pole teeth 12 on the lower side shown in FIG. 2 are magnetic poles at a certain instance. The S poles and the N poles are changed according to the directions of electric currents respectively flowing through the armature windings 2a and 2b.

In the armature unit 200, the armature winding 2a is arranged (wound) around the magnetic pole teeth 11 on the upper side of the armature iron cores 100 and 101 to be common to the armature iron cores 100 and 101. The armature winding 2b is arranged (wound) around the magnetic pole teeth 12 on the lower side of the armature iron cores 100 and 101. In this way, in the armature unit 200, the same armature windings 2a and 2b are respectively applied to a plurality of armature iron cores 100 and 101. The armature unit 200 can be configured irrespective of the number of the armature iron cores 100 and 101. The armature windings 2a and 2b may be directly wound (arranged) around the magnetic pole teeth 11 on the upper side and around the magnetic pole teeth 12 on the lower side of the armature iron cores 100 and 101. Alternatively, the armature windings 2a and 2b wound in advance may be respectively arranged around the magnetic pole teeth 11 on the upper side and the magnetic pole teeth 12 on the lower side.

The armature unit 200 is configured to form one phase of the linear motor R1. Three armature units 200 are arranged in the parallel arrangement direction of the armature iron cores 100 and 101 to configure a three-phase motor (see FIG. 18). In other words, m (m is an integer equal to or larger than 2) armature units 200 are arranged to configure an m-phase motor.

By adopting this configuration, the magnetic pole teeth 11 and 12 to which the same armature windings 2a and 2b are respectively applied respectively have the same magnetic poles. For example, when the linear motor R1 is in a certain phase, as shown in FIG. 2, the magnetic pole teeth 11 on the upper side are the N poles and the magnetic pole teeth 12 on the lower side are the S poles. When the linear motor R1 changes to the next phase, the magnetic pole teeth 11 on the upper side are the S poles and the magnetic pole teeth 12 on the lower side are the N poles. According to the repetition of this change of the magnetic poles, a mover 8 (see FIG. 4) including permanent magnets 3 arranged such that the polarities of the permanent magnets 3 adjacent to each other shown in FIG. 5 explained later are opposite (the N pole and the S pole) receives propulsion and moves in the direction in which the armature iron cores 100 and 101 are disposed in parallel (an arrow α1 direction in FIG. 2).

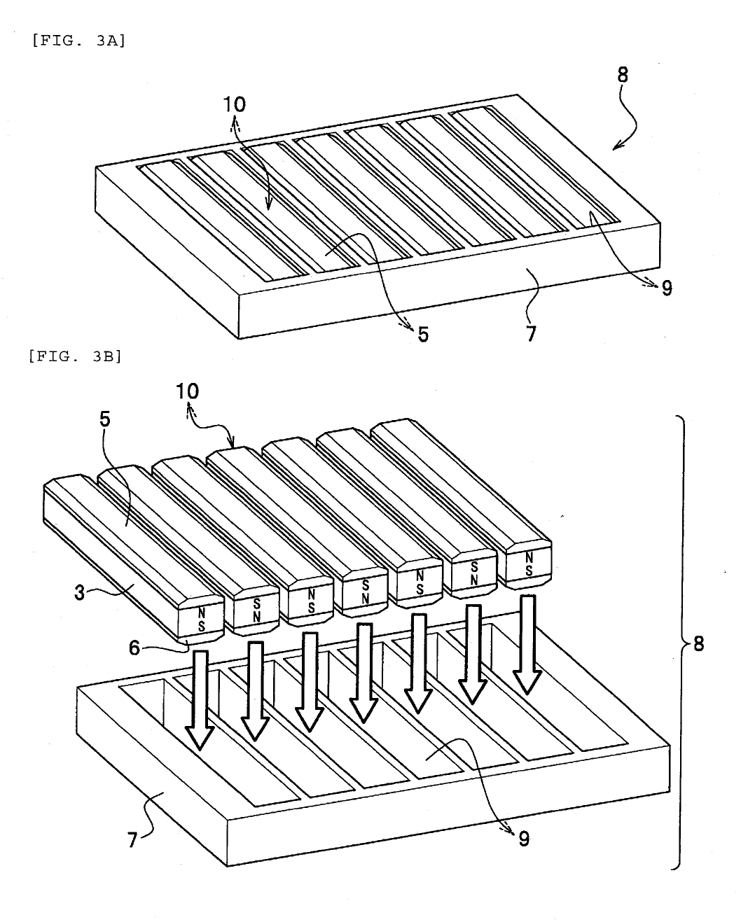

A perspective view of the mover 8 including a plurality of mover configuring members 10, which include high magnetic permeability members 5 and 6 (see FIG. 3B) and the permanent magnets 3, and a ladder-like mover holding member 7 is shown in FIG. 3A. A perspective view of an assembly process for fitting the plurality of mover configuring members 10, which include the high magnetic permeability members 5 and 6 and the permanent magnet 3, respectively into holes 9 of the mover holding member 7 and assembling the mover 8 is shown in FIG. 3B.

As shown in FIG. 3A, the mover 8 includes the ladder-like mover holding member 7 and the mover configuring members 10 respectively set in a ladder-like plurality of through-holes 9 of the mover holding member 7.

As explained above, the adjacent magnetic poles of the permanent magnet 3 are arranged to be opposite. For example, as shown in FIG. 3B, when one magnetic pole is the N pole in the permanent magnet 3, a magnetic pole of the permanent magnet 3 adjacent to the magnetic pole is the S pole and a magnetic pole of the permanent magnet 3 adjacent to the magnetic pole of the S pole is the N pole.

In the mover holding member 7, the plurality of through-holes 9 extending in the latitudinal direction of the mover holding member 7 are formed in a ladder shape in the center. The mover holding member 7 may be formed of a magnetic material or a non magnetic material. The material of the mover holding member 7 is not limited. As the magnetic member, for example, stainless steel such as SUS430, SS400, or S45C is used. As the nonmagnetic material, for example, stainless steel such as SUS303 or SUS304, aluminum, or titanium is used.

In the mover configuring member 10, high magnetic permeability members 5 and 6 are respectively set on the upper surface (a surface on one side) and the lower surface (a surface on the other side) of the permanent magnet 3 having a long rectangular parallelepiped shape using an adhesive or the like. As the adhesive, an epoxy adhesive or the like is used when heat is applied thereto. An acrylic adhesive or the like is used when heat is not applied thereto. However, the adhesive is selected as appropriated and is not limited.

As the permanent magnet 3, ferrite that is magnetized to the N pole or the S pole, has high coersivity, and is less easily demagnetized, a neodymium-iron-boron magnet or a samarium-cobalt magnet having strong magnetism, or the like is used. However, it goes without saying that the material of the permanent magnet 3 is not limited.

The high magnetic permeability members 5 and 6 are formed mainly of a magnetic material. As the magnetic material, for example, a material such as an iron material, a silicon steel plate, an amorphous alloy, or a dust core can be applied. The high magnetic permeability members 5 and 6 are desirably formed of a material having high magnetic permeability. However, the material of the high magnetic permeability members 5 and 6 is not limited to these materials as long as the same effect can be obtained.

The mover configuring members 10 shown in FIG. 3B are respectively fit into the ladder-like through-holes 9 of the mover holding member 7 and set using an adhesive or the like and the mover 8 is configured (see FIG. 3A). As the adhesive, an epoxy adhesive, an acrylic adhesive, or the like is used. However, the adhesive is not limited.

The mover 8 is inserted into the gap 4 between the magnetic pole teeth 11 and 12 of the armature unit 200 shown in FIG. 2. The mover 8 moves relatively to the fixed armature unit 200 in the direction in which the armature unit 200 is disposed in parallel (the arrow α1 direction in FIG. 2) with propulsion generated by magnetic fields of the mover 8 and the armature unit 200. This is a propulsion generating mechanism of the linear motor R1.

A perspective view of a part of the linear motor R1 including the propulsion generating mechanism in the first embodiment is shown in FIG. 4. A B-B line sectional view of FIG. 4 is shown in FIG. 5.

As explained above, the mover 8 is disposed in the gap 4 of the armature unit 200 including the armature iron cores 100 and 101 and the armature windings 2a and 2b respectively arranged in common in the armature iron cores 100 and 101.

Specifically, as shown in FIG. 5, the high magnetic permeability members 5 on the upper side and the high magnetic permeability members 6 on the lower side set on the permanent magnets 3 of the mover 8 are respective set to be opposed to the magnetic pole teeth 11 on the upper side and the magnetic pole teeth 12 on the lower side of the armature iron cores 100 and 101.

A pitch of the plurality of armature iron cores 100 and 101 is about 2nP (n is a positive integer, n=1, 2, 3, . . . ) with respect to a magnetic pole pitch P of the permanent magnets 3 in the mover 8. The armature iron cores 100 and 101 are magnetized such that the magnetic poles N and S of the adjacent permanent magnets 3 alternately change.

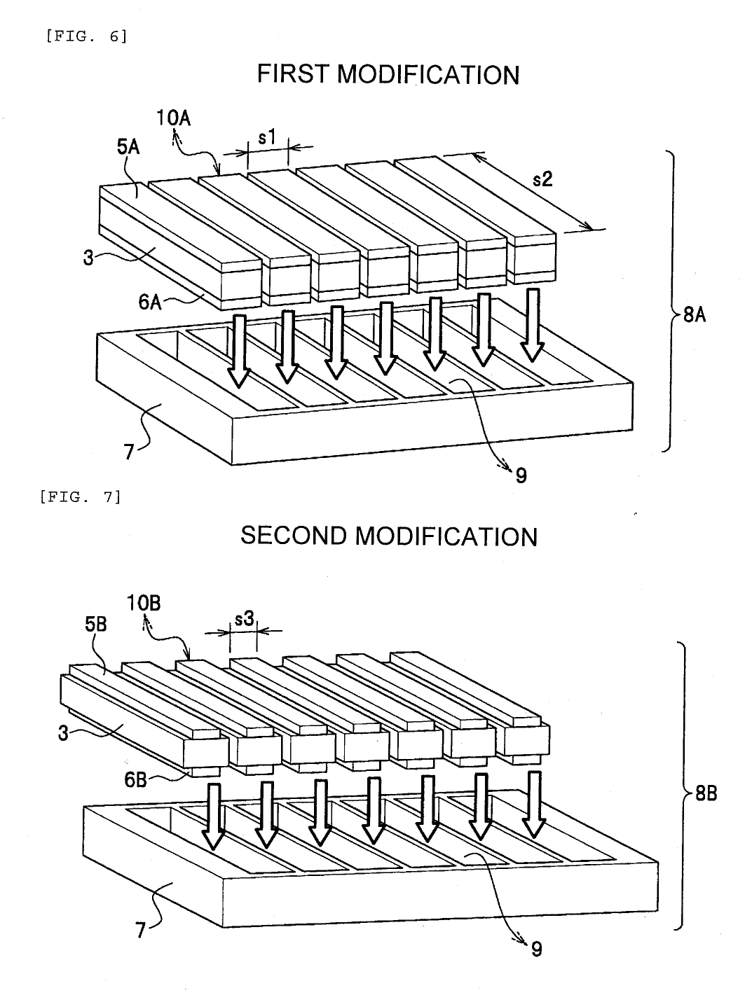

A diagram in which rectangular parallelepiped high magnetic permeability members 5A and 6A are set on the upper and lower surfaces (surfaces on one side and surfaces on the other side) of the permanent magnets 3 is shown in FIG. 6 as a first modification of the first embodiment (see FIGS. 3A and 3B).

In the first modification, the high magnetic permeability members 5A and 6A have a flat rectangular parallelepiped shape having a width dimension s1 and a length dimension s2 equal to those of the permanent magnets 3 having a long rectangular parallelepiped shape.

The high magnetic permeability members 5A and 6A are respectively set on the upper and lower surfaces of the respective permanent magnets 3 by bonding or the like. The high magnetic permeability members 5A and 6A configure mover configuring members 10A.

The mover configuring members 10A including the permanent magnets 3 and the high magnetic permeability members 5A and 6A are respectively set (embedded) in the through-holes 9 of the mover holding member 7. The mover configuring members 10A configure a mover 8A in the same manner as shown in FIG. 3A.

According to the first modification, the width and the length of the high magnetic permeability members 5A and 6A are the dimensions s1 and s2 same as the width and the length of the permanent magnets 3. The high magnetic permeability members 5A and 6A are configured such that the permanent magnets are not exposed to the outside of the high magnetic permeability members 5A and 6A. Therefore, even when the mover 8 collides with or comes into contact with the outside, it is possible to prevent a crack (damage) of the permanent magnets 3. Since the high magnetic permeability members 5A and 6A are arranged on the upper and lower surfaces of the mover configuring members 10A, for example, machining of the surfaces in a finishing process of the mover configuring members 10A and the mover 8 is easy.

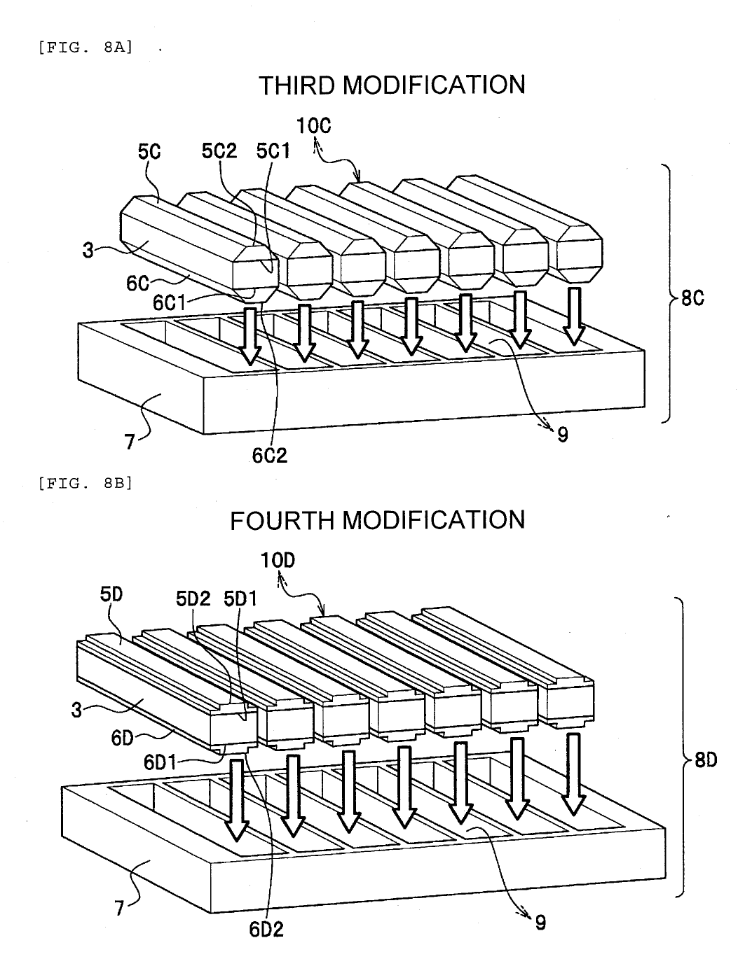

A perspective view in which rectangular parallelepiped high magnetic permeability members 5B and 6B narrower than the width of the permanent magnets 3 are set on the upper and lower surfaces of the permanent magnets 3 is shown in FIG. 7 as a second modification of the first embodiment.

In the second modification, the high magnetic permeability members 5B and 6B have a flat rectangular parallelepiped shape having a width dimension s3 smaller than the width of the magnets 3 having the long rectangular parallelepiped shape.

The high magnetic permeability members 5B and 6B having the small width are respectively set on the upper and lower surfaces (surfaces on one side and surfaces on the other side) of the permanent magnets 3. The high magnetic permeability members 5B and 6B configure mover configuring members 10B.

The mover configuring members 10B including the permanent magnets 3 and the high magnetic permeability members 5B and 6B narrower than the permanent magnets 3 are respectively set (embedded) in the through-holes 9 of the mover holding member 7. The mover configuring members 10B configure a mover 8B in the same manner as shown in FIG. 3A.

According to the second modification, the respective widths of the high magnetic permeability members 5B and 6B are the dimension s3 smaller than the width of the permanent magnets 3. Therefore, it is possible to concentrate magnetic fluxes (lines of magnetic force) on the center side of the permanent magnets 3 compared with the case in which wide high magnetic permeability members are used. Therefore, in the armature unit 200, it is possible to efficiently collect magnetic fluxes between the magnetic pole teeth 11 and 12. An effect such as improvement of a propulsion characteristic is attained.

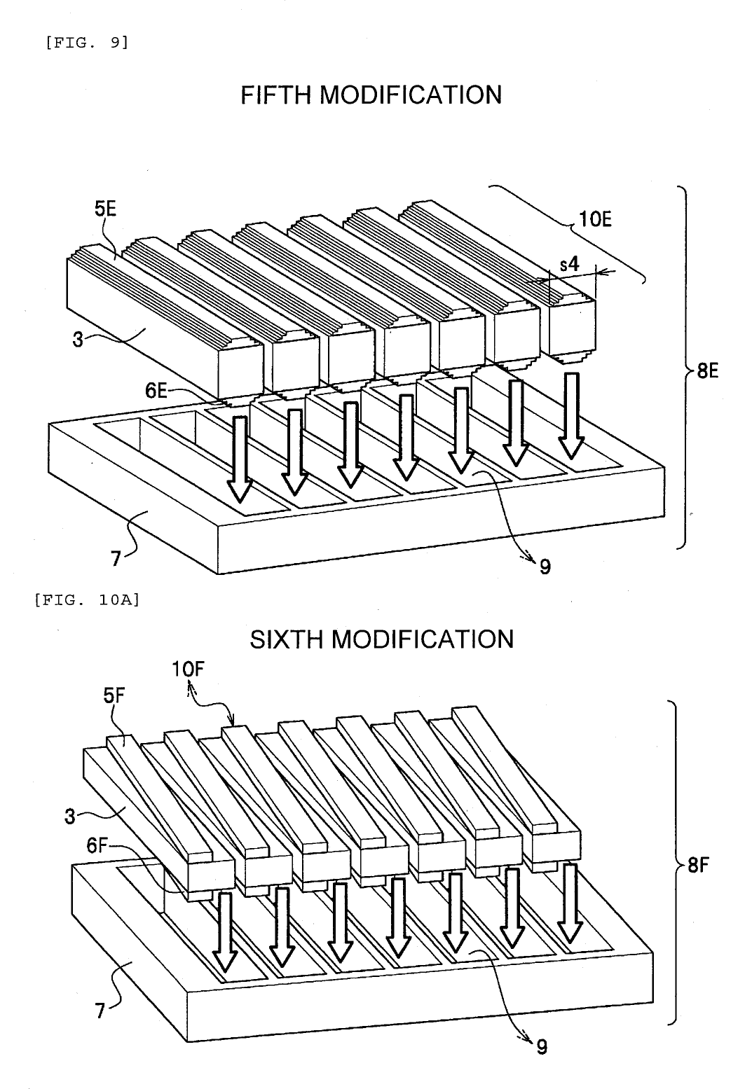

A diagram in which high magnetic permeability members 5C and 6C having a trapezoidal shape in cross section are set on the upper and lower surfaces of the permanent magnets 3 is shown in FIG. 8A as a third modification of the first embodiment.

The high magnetic permeability members 5C and 6C in the third modification are respectively set on the upper and lower surfaces of the permanent magnets 3 such that the sides of long lower bottoms 5C1 and 6C1 of the trapezoidal shape in cross section are adjacent to the permanent magnets 3. The high magnetic permeability members 5C and 6C configure mover configuring members 10C.

The mover configuring members 10C including the permanent magnets 3 and the high magnetic permeability members 5C and 6C are respectively set (embedded) in the through-holes 9 of the mover holding member 7. The mover configuring members 10C configure a mover 8C in the same manner as shown in FIG. 3A.

In the third modification, the sides of the long lower bottoms 5C1 and 6C1 of the trapezoidal shape in cross section of the high magnetic permeability members 5C and 6C are arranged to be adjacent to the permanent magnets 3. The sides of short upper bottoms 5C2 and 6C2 of the trapezoidal shape in cross section are arranged on the opposite sides of the permanent magnets 3 (the sides of the magnetic pole teeth 11 and 12 of the armature iron cores 100 and 101). Therefore, since the width of the high magnetic permeability members 5C and 6C decreases closer to the magnetic pole teeth 11 and 12, magnetic fluxes to the magnetic pole teeth 11 and 12 concentrate on the center side of the permanent magnets 3. It is possible to adjust a decrease in leak magnetic fluxes flowing to the magnetic poles of the adjacent permanent magnets 3 and magnetic flux density between the magnetic pole teeth 11 and 12. This leads to improvement of a propulsion characteristic of the linear motor R1.

A diagram in which high magnetic permeability members 5D and 6D having a convex shape are set on the upper and lower surfaces of the permanent magnet 3 is shown in FIG. 8B as a fourth modification of the first embodiment.

The high magnetic permeability members 5D and 6D having a convex shape in cross section in the fourth modification are respectively set to be opposed to the magnetic pole teeth 11 and 12 on the upper and lower surfaces (surfaces on one side and surfaces on the other side) of the permanent magnets 3. The high magnetic permeability members 5D and 6D configure mover configuring members 10D. The sides of lower sides 5D1 and 6D1 having a long dimension of the convex shape in cross section of the high magnetic permeability members 5D and 6D are adjacent to the permanent magnets 3. The sides of upper sides 5D2 and 6D2 having a short dimension of the convex shape in cross section are arranged on the opposite side of the permanent magnets 3 (the sides of the magnetic pole teeth 11 and 12 of the armature iron cores 100 and 101).

The mover configuring members 10D including the permanent magnets 3 and the high magnetic permeability members 5D and 6D are respectively set (embedded) in the through-holes 9 of the mover holding member 7. The mover configuring members 10D configure a mover 8D in the same manner as shown in FIG. 3A.

In the configuration of the fourth modification, the permanent magnets 3 are not exposed to the surface and the high magnetic permeability members 5D and 6D are narrowed in directions opposed to the magnetic pole teeth 11 and 12. Therefore, magnetic fluxes from the armature iron cores 100 and 101 and magnetic fluxes from the permanent magnets 3 are concentrated. It is possible to adjust a reduction in leak magnetic fluxes flowing to the magnetic poles of the adjacent permanent magnets 3 and magnetic flux density between the magnetic pole teeth 11 and 12. This leads to improvement of the propulsion characteristic of the linear motor R1.

A diagram in which high magnetic permeability members 5E and 6E having a step-like shape are set on the upper and lower surfaces of the permanent magnets 3 is shown in FIG. 9 as a fifth modification of the first embodiment.

The high magnetic permeability members 5E and 6E having the step-like shape in the fifth modification are set on the upper and lower surfaces (surfaces on one side and surfaces on the other side) of the permanent magnets 3. The high magnetic permeability members 5E and 6E configure mover configuring members 10E. The high magnetic permeability members 5E and 6E have a large width dimension s4 on the sides adjacent to the permanent magnets 3. The width dimension s4 decreases further away from the permanent magnets 3, i.e., closer to the magnetic pole teeth 11 and 12 of the armature iron cores 100 and 101.

The mover configuring members 10E including the permanent magnets 3 and the high magnetic permeability members 5E and 6E are respectively set (embedded) in the through-holes 9 of the mover holding member 7. The mover configuring members 10E configure a mover 8E in the same manner as shown in FIG. 3A.

According to the fifth modification, the mover 8E in which the step-like high magnetic permeability members 5E and 6E are set on the upper and lower surfaces of the permanent magnets 3 is formed in a shape taking into account that magnetic fluxes are effectively fed to the magnetic pole teeth 11 and 12 of the armature iron cores 100 and 101 without exposing the permanent magnets 3 to the outer side of the mover 8E. Therefore, it is possible to reduce a leak of magnetic fluxes of the permanent magnets 3 as much as possible and effectively feed the magnetic fluxes to the magnetic pole teeth 11 and 12.

In the third to fifth modifications, the several examples are illustrated in which the shape of the high magnetic permeability members is formed as the shape narrowed closer to the magnetic pole teeth 11 and 12. However, a shape other than those illustrated above such as a curved surface, a combination of a curved surface and a plane, and the like can be applied as appropriate as long as the shape is a shape narrowed closer to the magnetic pole teeth 11 and 12.

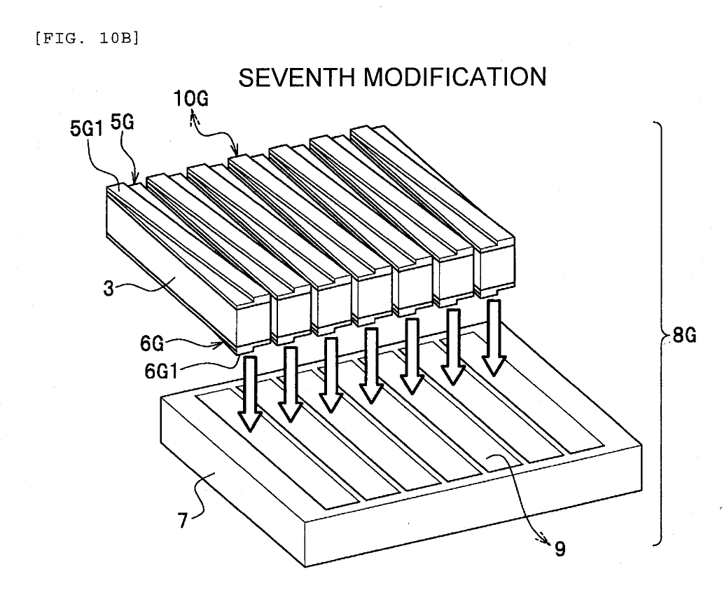

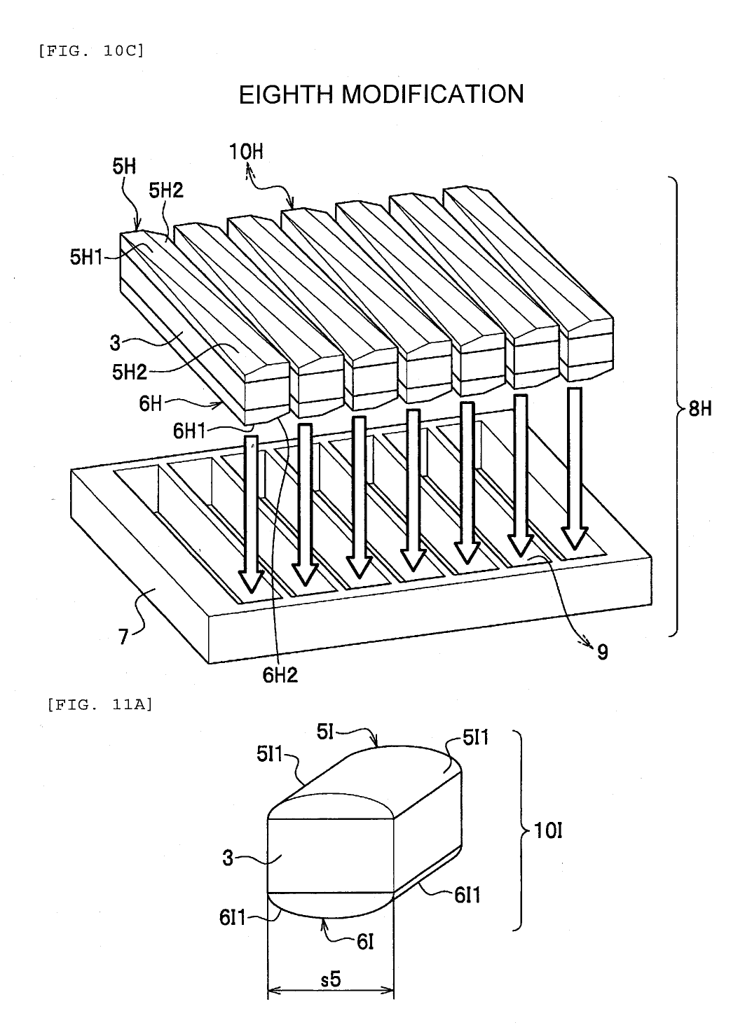

Diagrams in which high magnetic permeability members are set in a shape oblique to the magnetic pole teeth 11 and 12 on the upper and lower surfaces of the permanent magnets 3 are shown in FIGS. 10A to 10C as sixth, seventh, and eighth modifications of the first embodiment.

In the sixth modification shown in FIG. 10A, high magnetic permeability members 5F and 6F are set in a shape oblique to the magnetic pole teeth 11 and 12 on the upper and lower surfaces (surfaces on one side and surfaces on the other side) of the permanent magnets 3. In other words, in the sixth modification, the high magnetic permeability members 5F and 6F having a long flat parallelepiped shape are set on the upper and lower surfaces of the permanent magnets 3 having a long parallelepiped shape to be oblique to the magnetic pole teeth 11 and 12 of the armature iron cores 100 and 101. The high magnetic permeability members 5F and 6F configure mover configuring members 10F.

The mover configuring members 10F including the permanent magnets 3 and the high magnetic permeability members 5F and 6F are respective set (embedded) in the through-holes 9 of the mover holding member 7. The mover configuring members 10F configure a mover 8F in the same manner as shown in FIG. 3A.

In the seventh modification shown in FIG. 10B, upper sections 5G1 and 6G1 of high magnetic permeability members 5G and 6G having a long substantially flat rectangular parallelepiped shape extending along the magnetic pole teeth 11 and 12 of the armature iron cores 100 and 101 are formed in a rectangular parallelepiped shape oblique to the magnetic pole teeth 11 and 12.

Consequently, the high magnetic permeability members 5G and 6G having the long substantially flat rectangular parallelepiped shape are set on the upper and lower surfaces of the permanent magnets 3 such that the respective upper sections 5G1 and 6G1 of the high magnetic permeability members 5G and 6G opposed to the magnetic pole teeth 11 and 12 of the armature iron cores 100 and 101 are oblique. The high magnetic permeability members 5G and 6G configure mover configuring members 10G.

The mover configuring members 10G including the permanent magnets 3 and the high magnetic permeability members 5G and 6G are respectively set (embedded) in the through-holes 9 of the mover holding member 7. The mover configuring members 10G configure a mover 8G in the same manner as shown in FIG. 3A.

In the eighth modification shown in FIG. 10C, cutout sections 5H2 are formed in the materials of high magnetic permeability members 5H having a long flat parallelepiped shape such that upper surfaces 5H1 opposed to the magnetic pole teeth 11 (see FIG. 5) of the armature iron cores 100 and 101 are oblique. The high magnetic permeability members 5H are formed from the materials.

Similarly, cutout sections 6H2 are formed in the materials of high magnetic permeability members 6H having a long flat parallelepiped shape such that upper surfaces 6H1 opposed to the magnetic pole teeth 12 (see FIG. 5) of the armature iron cores 100 and 101 are oblique. The high magnetic permeability members 6H are formed from the materials.

The high magnetic permeability members 5H and 6H having a long substantially flat rectangular parallelepiped shape are set on the upper and lower surfaces of the permanent magnets 3 such that surfaces opposed to the respective magnetic pole teeth 11 and 12 of the armature iron cores 100 and 101 (respective upper surfaces 5H1 and 6H1 of the high magnetic permeability members 5H and 6H) are oblique. The high magnetic permeability members 5I1 and 6H configure mover configuring members 10H.

The mover configuring members 10H including the permanent magnets 3 and the high magnetic permeability members 5H and 6H are respectively set (embedded) in the through-holes 9 of the mover holding member 7. The mover configuring members 10H configure a mover 8H in the same manner as shown in FIG. 3A.

According to the sixth, seventh, and eighth modifications shown in FIGS. 10A to 10C, the high magnetic permeability members (5F, 6F, 5G, 6G, 5H, and 6H) are configured to be set oblique to the magnetic pole teeth 11 and 12 of the armature iron cores 100 and 101. Consequently, since a change in magnetic fluxes from the permanent magnets 3 becomes gentle, it is possible to obtain an effect same as an effect obtained when the permanent magnets 3 are skewed. Therefore, it is possible to reduce propulsion pulsation of the linear motor R1.

As in the first embodiment, the high magnetic permeability members 5A to 5H and 6A to 6H in the first to eighth modifications are formed mainly of a magnetic material. As the magnetic material, for example, there are materials such as an iron material, a silicon steel plate, an amorphous alloy, and a dust core. A material having high magnetic permeability is desirable. However, the magnetic material is not limited to these materials as long as the same effect can be obtained. If a material to be easily machined such as iron is used as the magnetic material, it is possible to form the high magnetic permeability members 5A to 5H and 6A to 6H in various shapes.

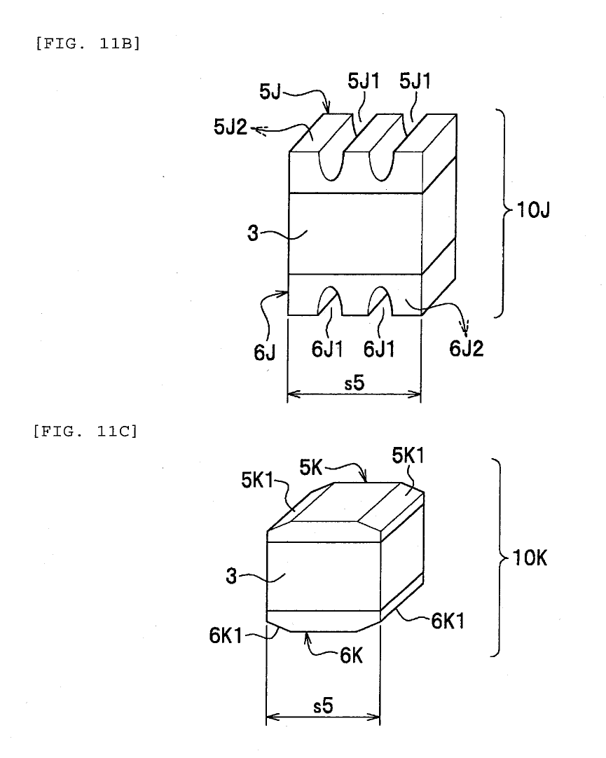

Examples of mover configuring members 10I, 10J, and 10K including high magnetic permeability members and permanent magnets 3 having various shapes are shown in FIGS. 11A, 11B, and 11C.

In the mover configuring member 10I shown in FIG. 11A, R sections 5I1 and 6I1 are formed at corners formed in the direction of width s5 of high magnetic permeability members 5I and 6I having a flat substantially rectangular parallelepiped shape set on the upper and lower surfaces of the permanent magnet 3. In other words, the corners formed in the direction of the width s5 of the high magnetic permeability members 5I and 6I are formed as the R sections 5I1 and 6I1 having a curvature.

Consequently, damage to the high magnetic permeability members 5I and 6I is suppressed. Since sides opposite to the permanent magnet 3 in the high magnetic permeability members 5I and 6I are formed narrow, magnetic fluxes concentrate and a leak of the magnetic fluxes is suppressed.

In the mover configuring member 10J shown in FIG. 11B, concave sections 5J1 and 6J1 of grooves extending in a direction orthogonal to the direction of the width s5 of high magnetic permeability members 5J and 6J having a flat substantially rectangular parallelepiped shape set on the upper and lower surfaces of the permanent magnet 3 are formed.

Consequently, magnetic fluxes are dispersed to concentrate on convex sections 5J2 and 6J2 on sides opposite to the permanent magnet 3 in the high magnetic permeability members 5J and 6J. The pulsation of the liner motor R1 is reduced.

In the mover configuring member 10K shown in FIG. 11C, chamfered sections 5K1 and 6K1 are formed at corners formed in the direction of the width s5 of high magnetic permeability members 5K and 6K having flat substantially rectangular parallelepiped shape set on the upper and lower surfaces of the permanent magnet 3.

Consequently, damage to the high magnetic permeability members 5K and 6K is suppressed. Since sides opposite to the permanent magnet 3 in the high magnetic permeability members 5K and 6K are formed narrow, magnetic fluxes concentrate and a leak of the magnetic fluxes is suppressed.

In general, if the thickness of the mover holding members (7) forming the mover (8) is increased and the thickness of the mover (8) (see FIG. 4) is increased, it is possible to improve the rigidity of the mover (8).

In the first embodiment and the modifications, when the thickness of the mover holding members (7) is increased, the thickness of the high magnetic permeability members (5, 6) set on the permanent magnets 3 is increased. Therefore, it is possible to improve the rigidity of the mover (8) without increasing the thickness of the permanent magnets 3. Further, since the high magnetic permeability members (5, 6) are set on the permanent magnets 3, magnetic resistance is not increased.

Therefore, it is possible to improve the rigidity of the mover 8 while having an excellent magnetic characteristic and without deteriorating a propulsion characteristic.

### Second Embodiment

A second embodiment of the present invention is explained.

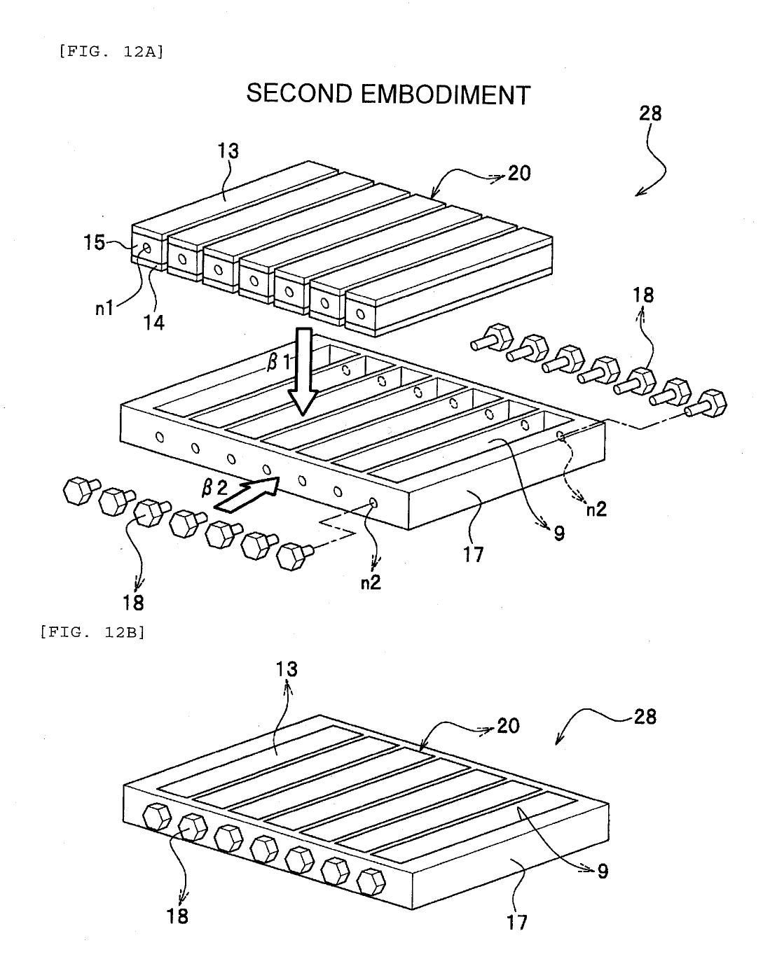

An assembly process for a mover 28 in the second embodiment is shown in FIG. 12A. The assembled mover 28 is shown in FIG. 12B.

In the second embodiment, a plurality of mover configuring members 20 in which permanent magnets 13 and 14 and high magnetic permeability members 15 are integrally configured are formed. A mover holding member 17 and the high magnetic permeability members 15 are fixed by screwing using screw holes n1 formed in the high magnetic permeability members 15 of the mover configuring members 20 to configure the mover 28.

As shown in FIG. 12A, the mover configuring members 20 in which the permanent magnets 13 and 14 are integrally set by bonding or the like on the upper and lower surfaces of the high magnetic permeability members 15 are formed. The screw holes n1 for fixing are respectively threaded at both end edges in the longitudinal direction of the high magnetic permeability members 15 in the mover configuring members 20.

A plurality of long-shape through-holes 9, in which a plurality of high magnetic permeability members 15 are fit, are formed in a ladder shape in the mover holding member 17. Insert-through holes n2, through which bolts 18 are inserted, are respectively drilled in places opposed to both end edges in the longitudinal direction of the through-holes 9.

When the mover 28 shown in FIG. 12B is assembled, the mover configuring members 20, in which the permanent magnets 13 and 14 are integrally set on the upper and lower surfaces of the high magnetic permeability members 15 shown in FIG. 12A, are respectively fit into the through-holes 9 of the mover holding member 17 as indicated by an arrow β1.

As indicate by an arrow β2, the bolts 18 are inserted through the insert-through holes n2 of the mover holding member 17 and screwed in the screw holes n1 of the high magnetic permeability members 15 of the mover configuring members 20. Consequently, a plurality of mover configuring members 20 are fixed to the mover holding member 17 by the bolts 18 and the mover 28 is configured (see FIG. 12B).

In the mover 28 in the second embodiment, the high magnetic permeability member 15 of the mover configuring member 20 and the mover holding member 17 can be fixed by fasteners such as the bolts 18. A fixing method may be any other mechanical method such as press fitting as long as the mover holding member 17 and the high magnetic permeability members 15 can be mechanically fixed.

In the past, when a mover includes only a mover holding member and permanent magnets, since it is difficult to open screw holes in the permanent magnets, a method of fixing the mover holding member and the permanent magnets with an adhesive is adopted. However, even if the permanent magnets 13 and 14, the high magnetic permeability members 15, and the mover holding members 17 are fixed using an adhesive, improvement of the rigidity of the mover is attained. When the permanent magnets 13 and 14, the high magnetic permeability members 15, and the mover holding members 17 are fixed using the adhesive, there are problems such as peeling of the adhesive due to heat and deterioration due to the elapse of time (aged deterioration).

On the other hand, according to the second embodiment, since a fixing method for the mover holding member 17 and the high magnetic permeability members 15 are mechanically fixed by the bolts 18 or the like, durability of a holding structure of the permanent magnets 13 and 14 is improved. It is possible to prevent deterioration in, for example, positioning accuracy for the permanent magnets 13 and 14 in the mover 28.

When the mover holding member 17 and the high magnetic permeability members 15 are fastened by the bolts 18 or the like, it is possible to individually remove the mover configuring members 20 (see FIG. 12A) including the permanent magnets 13 and 14. Replacement of the permanent magnets 13 and 14 is facilitated by replacing the mover configuring members 20.

### Third Embodiment

A third embodiment of the present invention is explained.

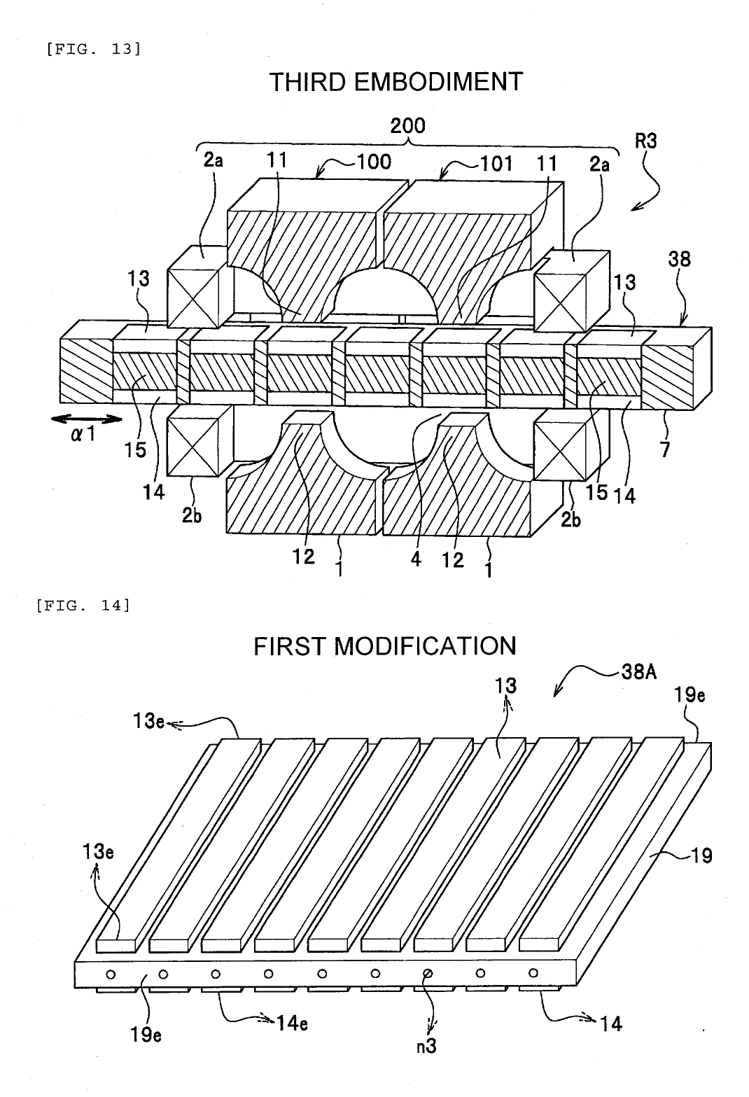

A longitudinal sectional view of the armature unit 200 including a mover 38 including two permanent magnets 13 and 14, the high magnetic permeability members 15 held between the permanent magnets 13 and 14, and the mover holding member 7 in the third embodiment is shown in FIG. 13.

In the third embodiment, the mover 38 is set to be movable in the arrow α1 direction between the magnetic pole teeth 11 on the upper side and the magnetic pole teeth 12 on the lower side of the respective armature iron cores 100 and 101. In the ladder-like mover holding member 7 of the mover 38, the high magnetic permeability members 15 are set between the permanent magnets 13 on the upper side arranged to be opposed to the magnetic pole teeth 11 on the upper side and the permanent magnets 14 on the lower side arranged to be opposed to the magnetic pole teeth 12 on the lower side.

Consequently, it is possible to increase the thickness of the mover holding member 7 by increasing the thickness of the high magnetic permeability members 15 without increasing an amount of magnets of the permanent magnets 13 and 14 and provide a linear motor R3 in which the rigidity of the mover 38 is high.

An example in which the permanent magnets 13 and 14 are set on the upper and lower surfaces of a long flat high magnetic permeability member 19 is shown in FIG. 14 as a first modification of the third embodiment.

In the first modification, a plurality of permanent magnets 13 and 14 are respectively set to be integrated on the upper and lower surfaces of the flat high magnetic permeability member 19 to configure a mover 38A.

In the first modification, since the high magnetic permeability member 19 can be configured by one member, it is possible to reduce the number of components. Since it is possible to configure the mover 38A without using a mover holding member, it is easy to design the mover 38A.

An example is explained below in which the mover 38A including the plurality of permanent magnets 13 and 14 respectively integrally set on the upper and lower surfaces of the flat high magnetic permeability member 19 shown in FIG. 14 are held from both sides and mechanically fixed by a pair of C-shaped mover holding members 20.

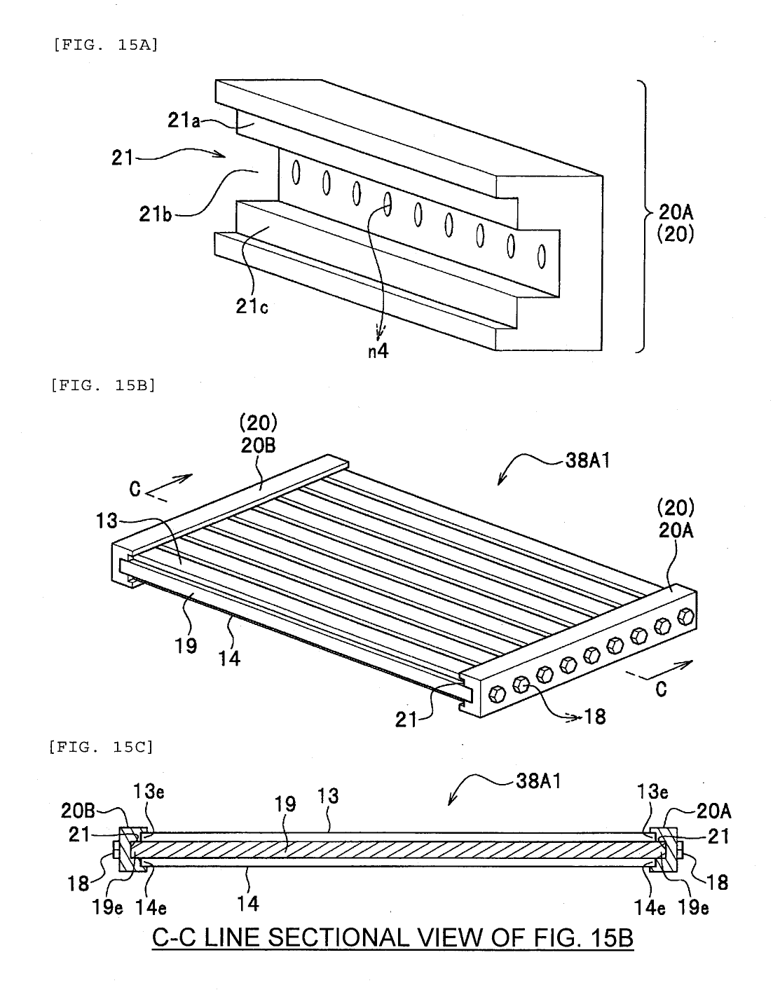

An example of a holding member (the C-shaped mover holding member 20 (20A)) that mechanically fixes the mover 38A in the first modification of the third embodiment is shown in FIG. 15A. A mover 38A1 including the flat high magnetic permeability member 19 and the permanent magnets 13 and 14 integrated by the C-shaped mover holding members 20 (20A and 20B) in the first modification of the third embodiment is shown in FIG. 15B. FIG. 15C is a C-C line sectional view of FIG. 15B.

When the mover 38A1 is manufactured, the pair of C-shaped mover holding members 20 (20A and 20B) including a cutout section 21 shown in FIG. 15A are formed. FIG. 15A shows one C-shaped mover holding member 20A. However, the other C-shaped mover holding member 20A (see FIG. 15B) has a shape symmetrical to the one C-shaped mover holding member 20A. Therefore, the one C-shaped mover holding member 20A is explained. Explanation of the other C-shaped mover holding member 20B is omitted.

The cutout section 21 of the C-shaped mover holding member 20A includes a first cutout section 21a in which an end edge 13e of the permanent magnet 13 shown in FIG. 14 is fit, a second cutout section 21b in which an end edge 19e of the high magnetic permeability member 19 is fit, and a third cutout section 21c in which an end edge 14e of the permanent magnet 14 is fit.

A plurality of insert-through holes n4, through which the bolts 18 are inserted, are drilled in the C-shaped mover holding member 20A.

When the mover 38A shown in FIG. 14 is held by the pair of C-shaped mover holding members 20, a plurality of screw holes n3 are threaded in advance at both end edges 19e of the high magnetic permeability member 19 of the mover 38A. When the mover 38A is not held by the pair of C-shaped mover holding members 20, it goes without saying that it is unnecessary to thread the plurality of screw holes n3.

When the mover 38A is held by the pair of C-shaped mover holding members 20A and 20B, first, the end edges 13e at both the ends of the permanent magnets 13, the end edges 19e of the high magnetic permeability members 19, and the end edges 14e at both the ends of the permanent magnets 14 of the mover 38A (see FIG. 14) are respectively fit in the cutout sections 21 of the respective C-shaped mover holding members 20A and 20B shown in FIGS. 15A and 15C.

The bolts 18 are inserted through the insert-through holes n4 of the C-shaped mover holding member 20A from the outer side. Thereafter, the bolts 18 are screwed in the screw holes n3 of the one end edges 19e of the high magnetic permeability members 19 of the mover 38A (see FIG. 14) fit in the cutout section 21 of the C-shaped mover holding member 20A (see FIG. 15C).

The bolts 18 are inserted through the insert-through holes n4 of the C-shaped mover holding member 20B from the outer side. Thereafter, the bolts 18 are screwed in the screw holes n3 of the other end edges 19e of the high magnetic permeability member 19 of the mover 38A fit in the cutout section 21 of the C-shaped mover holding member 20B to assemble the mover 38A1 (see FIG. 15B).

Consequently, the C-shaped mover holding members 20A and 20B and the high magnetic permeability members 19 are fixed by the bolts 18. The upper and lower permanent magnets 13 and 14 are mechanically held by the cutout sections 21 of the C-shaped mover holding members 20A and 20B. Consequently, it is possible to prevent the permanent magnets 13 and 14 from coming off the mover 38A1. Therefore, it is possible to improve durability of the mover 38A1.

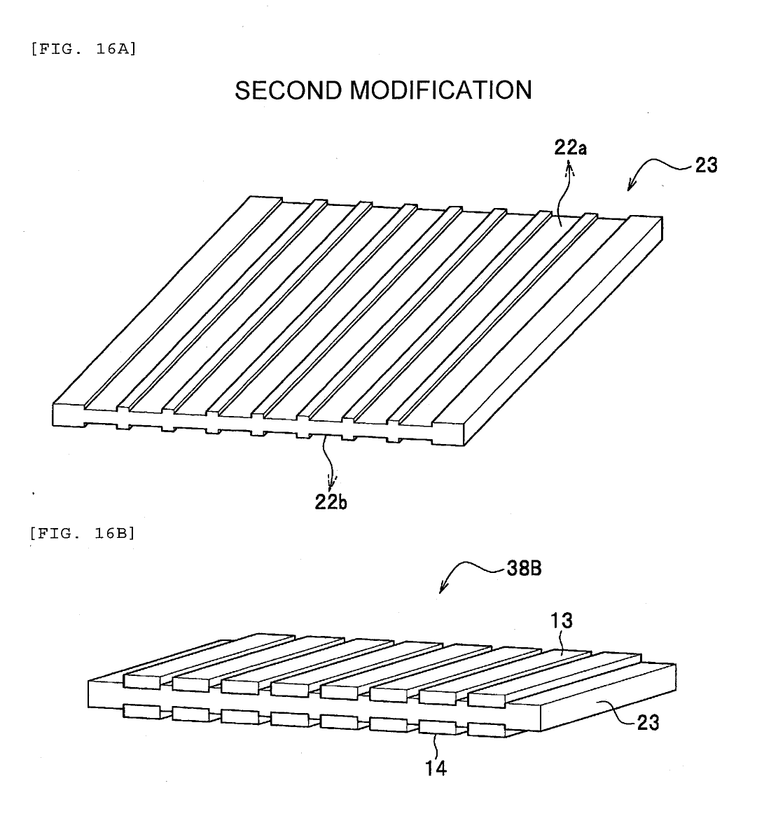

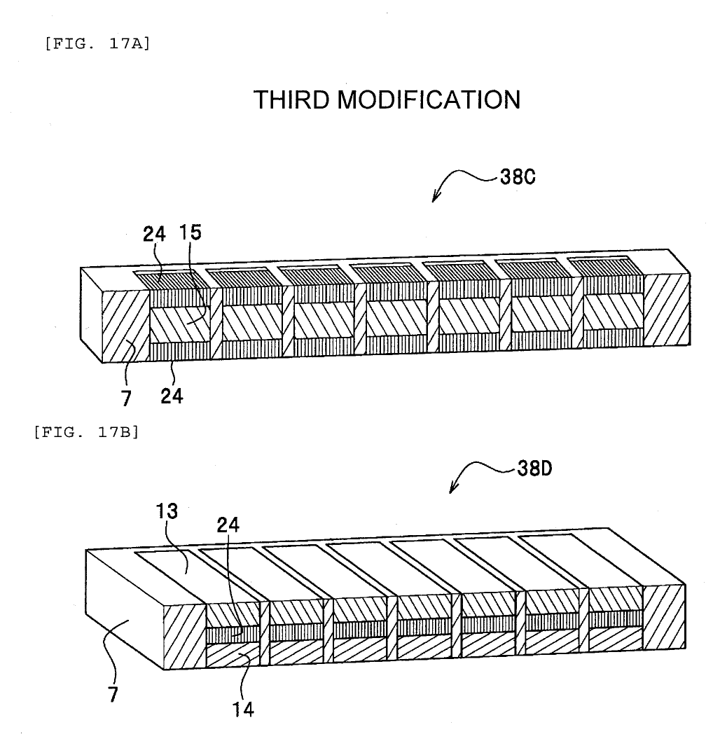

An example of a long flat high magnetic permeability member 23 in which grooves 22a and 22b are formed in a second modification of the third embodiment is shown in FIG. 16A. An example of a mover 38B configured by setting the permanent magnets 13 and 14 in the grooves 22a and 22b on the upper and lower surfaces of the high magnetic permeability member 23 in the second modification of the third embodiment is shown in FIG. 16B.

In the high magnetic permeability member 23 shown in FIG. 16A, a plurality of flat rectangular parallelepiped grooves 22a and 22b are formed on the upper and lower surfaces thereof are formed.

The permanent magnets 13 are set in a plurality of grooves 22a on the upper surface of the high magnetic permeability member 23 by bonding or the like and the permanent magnets 14 are set in a plurality of grooves 22b on the lower surface of the high magnetic permeability member 23 by bonding or the like to configure the mover 38B (see FIG. 16B).

According to the second modification, the permanent magnets 13 and 14 are respectively set in the grooves 22a and 22b provided in the high magnetic permeability member 23. Therefore, since bonding surfaces between the permanent magnets 13 and 14 and the grooves 22a and 22b of the high magnetic permeability member increase, adhesiveness is improved. Further, since the permanent magnets 13 and 14 are respectively set in the grooves 22a and 22b, the permanent magnets 13 and 14 are positioned by the grooves 22a and 22b, positioning accuracy of the permanent magnets 13 and 14 is improved, and the permanent magnets 13 and 14 are stabilized.

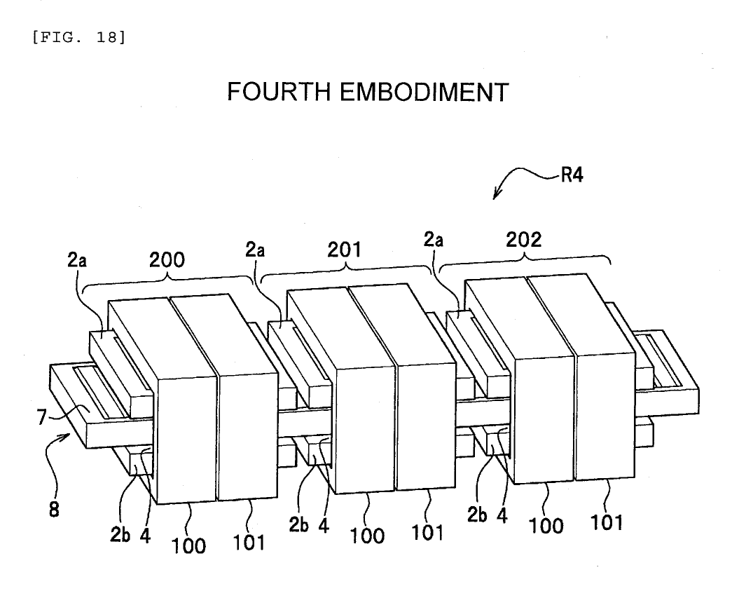

An example of movers 38C and 38D that reduce a loss of an eddy current generated from high magnetic permeability members in a third modification of the third embodiment is shown in FIGS. 17A and 17B as longitudinal sectional views.

In FIG. 17A, the mover 38C in which the permanent magnets 15 and high magnetic permeability members including laminated members 24 set on the upper and lower surfaces of the permanent magnets 15 are set in the mover holding member 7 is shown. The laminated members 24 of the high magnetic permeability members are formed by laminating, for example, thin steel plates.

In FIG. 17B, a mover 38D in which the permanent magnets 13 and 14 and high magnetic permeability members including the laminated members 24 held between the permanent magnets 13 and 14 are set in the mover holding member 7 is shown. The laminated members 24 of the high magnetic permeability members are formed by laminating, for example, thin steel plates in the same manner as shown in FIG. 17A.

As shown in FIGS. 17A and 17B, when the high magnetic permeability members are configured by the laminated members 24, since the electric resistance of the high magnetic permeability members increases, an eddy current is suppressed. It is possible to reduce an eddy current loss. As a member for reducing an eddy current loss, besides a laminated member, there is, for example, a member formed by slitting a high magnetic permeability material. However, the member is not limited to these configurations as long as the same effect can be obtained.

### Fourth Embodiment

A fourth embodiment of the present invention is explained.

The fourth embodiment in which three armature units 200, 201, and 202 using the movers in the first to third embodiments of the present invention is shown in FIG. 18.

In the fourth embodiment, a three-phase liner motor R4 is configured by arranging the three armature units 200, 201, and 202 at an interval equivalent to 120° in an electric angle using the movers explained in the first to third embodiments.

In FIG. 18, the three-phase linear motor R4 is illustrated. However, it is also possible to configure, by arranging an arbitrary plurality of armature units 200, 201, 202, and the like, a linear motor of multiple phases of an arbitrary number selected as appropriate.

According to the first to fourth embodiments, the high magnetic permeability members are set in the permanent magnets included in the mover and the thickness of the mover holding member is increased in order to increase the rigidity of the mover. Consequently, it is possible to suppress an increase in magnetic resistance when the thickness of the mover is increased while keeping rigidity. Therefore, it is possible to suppress an amount of permanent magnets.

Therefore, the magnetic resistance does not increase even if the mover thickness is increased. It is possible to reduce an amount of magnets.

Therefore, it is possible to realize a highly reliable linear motor including a mover having an excellent magnetic characteristic, has high rigidity, and less easily bends.

In the embodiments and the modifications of the embodiment, the combination in which the permanent magnet side is the mover and the armature side is the stator is illustrated. However, since mover and the armature relatively move, it is possible to adopt a configuration in which the armature side is the mover and the permanent magnet side is the stator.

In the embodiments and the modifications, the components are individually explained. However, these components can also be configured to be combined as appropriate.

### REFERENCE SIGNS LIST

1 iron core (core)
2a armature winding
2b armature winding
3 permanent magnets
4 gap
5, 5D, 5I, 5J, 5K high magnetic permeability members
6, 6D, 6I, 6J, 6K high magnetic permeability members
5A, 6A high magnetic permeability members (rectangular parallelepiped high magnetic permeability members)
5B, 6B high magnetic permeability members (high magnetic permeability members having width smaller than width of permanent magnets)
5C, 6C high magnetic permeability members (high magnetic permeability members having a trapezoidal shape in cross section)
5E, 6E high magnetic permeability members (high magnetic permeability members having width narrowed closer to magnetic pole teeth)
5F, 5G, 5H, 6F, 6G, 6H high magnetic permeability members (high magnetic permeability members, surfaces of which opposed to magnetic pole teeth have an oblique shape)
7, 20 mover holding members
8, 8A to 8H, 28, 38, 38A, 38A1, 38B, 38C, 38D movers
11, 12 magnetic pole teeth
13 permanent magnets (permanent magnets forming a row, permanent magnets set in grooves of high magnetic permeability members)
14 permanent magnets (permanent magnets forming a row, permanent magnets set in grooves of high magnetic permeability members)
15 high magnetic permeability members (high magnetic permeability members mechanically fixed to mover holding member)
17 mover holding member (mover holding member mechanically fixed to high magnetic permeability members)
19 high magnetic permeability members (high magnetic permeability members held between rows of permanent magnets)
22a, 22b grooves (groove sections formed in high magnetic permeability members)
23 high magnetic permeability members (high magnetic permeability members in which grooves are set)
24 laminated members (high magnetic permeability members, laminated members)
100, 101 armature iron cores
200, 201, 202 armature units (armatures)
2np pitch of armature iron cores
P magnetic pole pitch
R1, R3, R4 linear motors

1. A linear motor comprising a propulsion generating mechanism that enables an armature including an armature iron core and an armature winding wound around magnetic pole teeth of the armature iron core and a mover including permanent magnets to move relatively to each other,
the armature iron core including the magnetic pole teeth on both sides respectively arranged to be opposed to both surfaces on one side and the other side of the permanent magnets via a gap and a core that connects the magnetic pole teeth on both the sides,
a common armature winding being arranged on a plurality of the armature iron cores, characterized in that
the mover includes the permanent magnets and high magnetic permeability members.

2. The linear motor according to claim 1, wherein
a pitch of the plurality of armature iron cores is about 2nP (n is a positive integer, n=1, 2, 3, . . . ) with respect to a magnetic pole pitch P of the permanent magnets in the mover,
magnetic poles of the permanent magnets adjacent to each other are magnetized to alternately change, and
the magnetic pole teeth on one side among the magnetic pole teeth on both the sides of the plurality of armature iron cores have same polarity.

3. The linear motor according to claim 1, wherein the high magnetic permeability members are set on surfaces of the permanent magnets respectively opposed to the magnetic pole teeth on both the sides.

4. The linear motor according to claim 3, wherein a shape of the high magnetic permeability members are a rectangular parallelepiped.

5. The linear motor according to claim 3, wherein a shape of the high magnetic permeability member is formed in a shape narrowed closer to the magnetic pole teeth.

6. The linear motor according to claim 3, wherein a shape of the high magnetic permeability members is a trapezoidal shape in a cross section thereof.

7. The linear motor according to claim 3, wherein a shape of the high magnetic permeability members is formed in a step shape having width that decreases closer to the magnetic pole teeth.

8. The linear motor according to claim 3, wherein the high magnetic permeability members are formed to have a shape oblique to the magnetic pole teeth.

9. The linear motor according to claim 4, wherein width of the high magnetic permeability members in a direction in which the mover moves is smaller than width of the permanent magnets.

10. The linear motor according to claim 1, wherein the high magnetic permeability members are arranged to be held between two rows of the permanent magnets arranged to be respectively opposed to the magnetic pole teeth on both the sides of the armature iron core.

11. The linear motor according to claim 1, wherein a mover holding member that holds the permanent magnets and the high magnetic permeability members in the mover is mechanically fixed to the high magnetic permeability members.

12. The linear motor according to claim 10, wherein the permanent magnets are set in groove sections formed in the high magnetic permeability members.

13. The linear motor according to claim 1, wherein the high magnetic permeability members are configured by laminated members.

14. The linear motor according to claim 1, wherein the armature is set on a moving movable side and a mover is set on a fixed side.
